(19) United States
(12) Patent Application Publication
(10) Pub. No.: US 2019/0024495 A1
(43) Pub. Date: Jan. 24, 2019

(54) PARAMETER BASED ROADMAP GENERATION FOR DOWNHOLE OPERATIONS

(71) Applicant: LANDMARK GRAPHICS CORPORATION, HOUSTON, TX (US)

(72) Inventors: Matthew E. Wise, Sugar Land, TX (US); Gustavo Urdaneta, Houston, TX (US); Mahesh Kumar Thandra Aswinikumar, Sugarland, TX (US)

(21) Appl. No.: 16/081,386

(22) PCT Filed: Apr. 14, 2016
(86) PCT No.: PCT/US2016/027508

§ 371 Date: Aug. 30, 2018

(51) Int. Cl. E21B 44/00; E21B 41/00; G06F 17/50

(52) U.S. Cl. CPC E21B 44/00; G06F 17/5009; E21B 41/0092

(57) ABSTRACT

System and methods for automating well planning and data analysis for downhole operations are provided. Values of one or more operational variables are estimated for each of a plurality of operating intervals, based on a user-selected optimization parameter. The estimated values of the one or more operational variables are provided as inputs to a downhole tool for performing the downhole operation over a current one of the operating intervals along the planned well path. Responsive to receiving an indication that a condition in the well has changed while the downhole operation is performed during the current operating interval, subsequent operating intervals are updated along with the estimated values of the operational variable(s) for each subsequent operating interval. The planned well path is then adjusted by providing the updated values of the operational variable(s) as inputs to the downhole tool for performing the downhole operation over the subsequent operating intervals.

### FIELD OF THE DISCLOSURE

The present disclosure relates generally to well planning and analysis of well string operations, and particularly, to engineering tools for well planning and operations analysis.

### BACKGROUND

In many instances, drilling operations and other operations associated with recovery of hydrocarbons from a subterranean zone are performed by relying on measurement information sent from downhole tools and equipment during the operation without visually monitoring the operation. The measurement information may be of various data types measured by sensors and logged in certain industry database standards. Such information may be used to monitor the progress of the operation and enable a well operator to make appropriate adjustments to various parameters of the operation.

For example, a well operator may use such downhole information to assess current well conditions and make any appropriate adjustments to an existing well plan over the course of a drilling operation. This generally requires the well operator to consider many variables, some interrelated, when making decisions regarding implementing the well plan. However, the ability to effectively analyze the well plan based on a large number of operational variables can prove to be difficult for the well operator, particularly where the variables are associated with different types of analyses that may need to be performed multiple times at varying depths over the course of the drilling operation.

### BRIEF DESCRIPTION OF THE DRAWINGS

FIG. 1 is a diagram of an illustrative drilling system for conducting a downhole operation at a well site.

FIG. 2 is a block diagram of an illustrative system automating well planning and data analysis for downhole operations.

FIG. 3 is a block diagram of an illustrative data analysis unit of the well planning system of FIG. 2.

FIG. 4 is a flowchart of an illustrative process for automated well planning and data analysis for downhole operations.

FIG. 5 is a view of an illustrative graphical user interface (GUI) of a well engineering application for automated well planning and data analysis.

FIG. 6 is a diagram illustrating an example of an output visualization panel including an interactive data plot for defining or adjusting depth ranges along a planned path of a well via the GUI of FIG. 5.

FIG. 7 is a diagram of an illustrative selection control panel for selecting operational variables of interest via the GUI of FIG. 5.

FIG. 8 is a view of another illustrative GUI of the well engineering application for specifying operational variables related to a torque and drag analysis.

FIG. 9 is a block diagram of an exemplary computer system in which embodiments of the present disclosure may be implemented.

### DESCRIPTION OF ILLUSTRATIVE EMBODIMENTS

Embodiments of the present disclosure relate to automating well planning and data analysis for drilling operations. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to implement such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

The disclosure may repeat reference numerals and/or letters in the various examples or figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) illustrated, the upward direction being toward the top of the corresponding figure, the downward direction being toward the bottom of the corresponding figure, the uphole and upstream directions being toward the surface of the wellbore, and the downhole and downstream directions being toward the toe of the wellbore. Likewise, the term “proximal” may be used herein to refer to the upstream or uphole direction with respect to a particular component of a drill string, and the term “distal” may be used herein to refer to the downstream or downhole direction with respect to a particular drill string component. Unless otherwise stated, the spatially relative terms are intended to encompass different orientations of the apparatus in use or operation in addition to the orientation depicted in the figures. For example, if an apparatus in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a figure may depict a vertical wellbore, unless indicated otherwise, it should be understood by those skilled in the art that the apparatus according to the present disclosure is equally well suited for use in wellbores having other orientations including horizontal wellbores, deviated or slanted wellbores, multilateral wellbores or the like. Likewise, unless otherwise noted, even though a figure may depict an onshore operation, it should be understood by those skilled in the art that the apparatus according to the present disclosure is equally well suited for use in offshore operations and vice-versa. Further, unless otherwise noted, even though a figure may depict a cased hole, it should be understood by those skilled in the art that the apparatus according to the present disclosure is equally well suited for use in open hole operations.

As will be described in further detail below, embodiments of the present disclosure may be used to facilitate the generation and visualization of optimal parameters and operational variables for performing different stages of a downhole operation. Such an operation may be, for example, a drilling operation involving drilling a well along a planned path toward a target zone of hydrocarbon deposits within a subsurface formation. The stages of the drilling operation in this example may correspond to a plurality of operating intervals in which the well is drilled along the planned path within the formation. Each operating interval may be, for example, a range of depth over which a portion of the well is drilled along the planned path. Alternatively, each operating interval may be a range of time during which a portion of the well is drilled. In one or more embodiments, optimal values of operational variables estimated for each of the plurality of operating intervals may be provided as part of a roadmap for performing the downhole operation along the planned well path, e.g., for drilling the well along the planned path over different operating intervals or stages of the operation.

As used herein, the term “operational variable” refers to a variable of the downhole operation that can be adjusted during the downhole operation to control how the operation is performed along the planned well path. Examples of such controllable drilling parameters include, but are not limited to, weight on bit, drilling fluid flow through the drill pipe, the drill string rotational speed, and the density and viscosity of the drilling fluid. In one or more embodiments, a set of operational variables may be used to calculate the value of an “optimization parameter” related to a particular characteristic of the downhole operation that can be monitored and controlled using the set of operational variables. The optimization parameter may be used, for example, to monitor the particular characteristic of the downhole operation as it is being performed over each of the plurality of operating intervals and adjust one or more operational variables in order to optimize the downhole operation with respect to the particular characteristic being monitored.

In one or more embodiments, the operating interval (e.g., depth or time range) corresponding to each stage of the operation may be specified by a user or defined automatically based on data analysis results. The data analysis may include estimating values of operational variables used to calculate an optimization parameter fix each operating interval. The estimated values may be provided as control inputs to a well site control system for performing the downhole operation along the planned well path by controlling a downhole geosteering tool. The operating intervals and estimated values may be automatically updated based on a comparison between the expected and actual values of the optimization parameter calculated during or after each operating interval of the downhole operation. The actual values of the optimization parameter may be calculated based on real-time data collected from the well and any operational constraints specified by the user. The updated variables for a current interval or stage of the operation may also be used to dynamically adjust or optimize the planned path of the well for subsequent operating intervals by providing the updated variables as new control inputs to the well site control system for automated control of the downhole geosteering tool. In some implementations, the updated variables may be recommended to the user as part of an automated workflow to facilitate well planning for the user and optimize the downhole operation during each operating interval and stage of the operation.

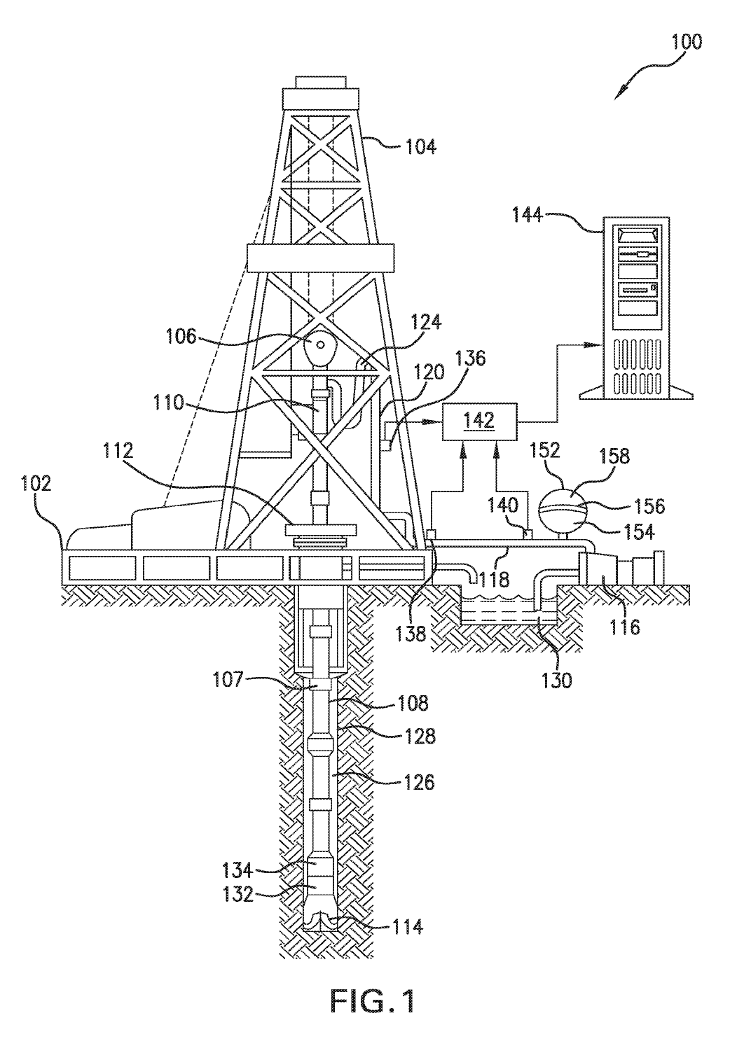

Illustrative embodiments and related methodologies of the present disclosure are described below in reference to FIGS. 1-9 as they might be employed, for example, in a computer system for planning and monitoring a downhole operation at a well site. Such an operation may include, for example and without limitation, drilling, casing, and completion operations. In one or more embodiments, the computer system may execute a well engineering application for automating well planning and data analysis workflows during both planning and implementation phases of a downhole operation. For example, the well engineering application may be used by a well site operator during a planning phase of the operation to determine optimal parameters or variables for different operating intervals of the operation along the planned path of the well within the formation. During an implementation phase of the operation, the operating intervals and associated operational parameters/variables may be automatically updated based on the analysis of downhole data obtained from the actual well along its the planned path.

Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 is a diagram of an illustrative drilling system 100 for conducting a drilling operation at a well site. As shown in FIG. 1, system 100 includes a drilling platform 102 located at the surface of a borehole or wellbore 126. Wellbore 126 is drilled into different layers of a subsurface rock formation using a drill string 108 that includes a string of drill pipes connected together by “tool” joints 107. Drilling platform 102 is equipped with a derrick 104 that supports a hoist 106. Hoist 106 suspends a top drive 110 that is used to lower drill string 108 through a wellhead 112 and rotate drill siting 108 within wellbore 126. Connected to the lower portion or distal end of drill string 108 is a bottom hole assembly (BHA), which includes a drill bit 114, at least one downhole tool 132, and a telemetry device 134. It should be appreciated that drill bit 114, downhole tool 132, and telemetry device 134 may be implemented as separate components within a housing of the BHA at the end of drill string 108. Although not shown in FIG. 1, it should also be appreciated that the BHA may include additional components for supporting various functions related to the drilling operations being conducted. Examples of such components include, but are not limited to, drill collars, stabilizers, reamers, and hole-openers.

Drilling of wellbore 126 occurs as drill bit 114 penetrates the subsurface formation while rotating at the end of drill string 108. Drill bit 114 may be rotated in conjunction with the rotation of drill string 108 by top drive 110. Additionally or alternatively, drill bit 114 may be rotated independently from the rest of drill string 108 by a downhole motor (not shown) positioned near drill bit 114. Although wellbore 126 is shown in FIG. 1 as a vertical wellbore, it should be appreciated that wellbore 126 may be drilled in a non-vertical, horizontal, or near-horizontal direction, e.g., as a deviated well drilled at angles approaching or at 90 degrees from vertical.

Drilling fluid may be pumped at high pressures and volumes by a mud pump 116 through a flow line 118, a stand pipe 120, a goose neck 124, top drive 110, and drill string 108 to emerge through nozzles or jets in drill bit 114. The drilling fluid emerging from drill bit 114 travels back up wellbore 126 via a channel or annulus formed between the exterior of drill string 108 and a wellbore wall 128. The drilling fluid then goes through a blowout preventer (not specifically shown) and into a mud pit 130 at the surface, where the fluid is cleaned and recirculated by mud pump 116 through drill string 108 and wellbore 126. The drilling fluid may be used for various purposes during the drilling operation including, but not limited to, cooling drill bit 114, carrying cuttings from the base of the bore to the surface, and balancing the hydrostatic pressure in the rock formations.

Downhole tool 132 may be used to collect information related to downhole drilling conditions and surrounding formation properties as wellbore 126 is drilled over different stages of the drilling operation. Downhole tool 132 may be, for example, a logging-while-drilling (LWD) or a measurement-while-drilling (MWD) tool for measuring such downhole conditions and formation properties. The measured downhole conditions may include, for example and without limitation, the movement, location, and orientation of the BHA or drilling assembly as wellbore 126 is drilled within the formation. The measured formation properties may include, for example, one or more formation parameters around a circumference of wellbore 126 at a particular depth within the formation. While only downhole tool 132 is shown in FIG. 1, it should be appreciated that the disclosed embodiments are not limited thereto and that additional downhole tools (e.g., any number of MWD and/or LWD tools) may be used. Also, it should be appreciated that while distinctions between MWD and LWD may exist, the terms MWD and LWD are often used interchangeably. For purposes of this disclosure, it should be noted that the term “downhole tool” may refer to both the collection of formation parameters and the collection of information relating to the movement and position of the drilling assembly.

In one or more embodiments, the information collected by downhole tool 132 may be transmitted to the surface via telemetry module 134. Telemetry module 134 may be part of a communication subsystem of drill string 108. Telemetry module 134 may be communicatively coupled to downhole tool 132 for receiving data related to the formation properties and downhole conditions measured and/or recorded by downhole tool 132. Telemetry module 134 may communicate the received data to the surface using any suitable communication channel (e.g., pressure pulses within the drilling fluid flowing in drill string 108, acoustic telemetry through the pipes of the drill string 108, electromagnetic telemetry, optical fibers embedded in the drill string 108, or any combination thereof).

In the example shown in FIG. 1, drilling system 100 may employ mud pulse telemetry for transmitting downhole information collected by downhole tool 132 to the surface during the drilling operation. However, it should be appreciated that embodiments are not limited thereto and that any of various other types of data communication techniques may be used for sending the downhole information to the surface. Such techniques may include, for example and without limitation, wireless communication techniques and wireline or any other type of wired electrical communication techniques.

In the mud pulse telemetry example, telemetry device 134 may encode the downhole information using a data compression scheme and transmit the encoded data to the surface by modulating the flow of drilling fluid through drill siting 108 so as to generate pressure pulses that propagate to the surface. The pressure pulses may be received at the surface by various transducers 136, 138 and 140, which convert the received pulses into electrical signals for a signal digitizer 142 (e.g., an analog to digital converter). While three transducers 136, 138 and 140 are shown in FIG. 1, a greater or fewer number of transducers may be used as desired for a particular implementation. Digitizer 142 supplies a digital form of the pressure signals to a data processing device or computer 144.

In one or more embodiments, computer 144 may function as a control system for monitoring and controlling downhole operations at the well site. Computer 144 may be implemented using any type of computing device having at least one processor and a memory. Computer 144 may process and decode the digital signals received from digitizer 142 using an appropriate decoding scheme. For example, the digital signals may be in the form of a bit stream including reserved bits that indicate the particular encoding scheme that was used to encode the data downhole. Computer 144 can use the reserved bits to identify the corresponding decoding scheme to appropriately decode the data. The resulting decoded telemetry data may be further analyzed and processed by computer 144 to display useful information to a well site operator. For example, a driller could employ computer 144 to obtain and monitor the position and orientation of the BHA (or one or more of its components), other drilling parameters, and/or one or more formation properties of interest over the course of the drilling operation. It should be appreciated that computer 144 may be located at the surface of the well site, e.g., near drilling rig 104, or at a remote location from the well site. While not shown in FIG. 1, computer 144 may be communicatively coupled to one or more other computer systems via a communication network, e.g., a local area, medium area, or wide area network, such as the Internet. Such other computer systems may include remote computer systems located away from the well site for remotely monitoring and controlling well site operations via the communication network.

To reduce noise in the downhole data received at the surface, drilling system 100 may include a dampener or desurger 152 to reduce noise. Flow line 118 couples to a drilling fluid chamber 154 in desurger 152. A diaphragm or separation membrane 156 separates the drilling fluid chamber 154 from a gas chamber 158. Desurger may include a gas chamber 158 filled with nitrogen at a predetermined percentage, e.g., approximately 50% to 75% of the operating pressure of the drilling fluid. The diaphragm 156 moves with variations in the drilling fluid pressure, enabling the gas chamber to expand and contract, thereby absorbing some of the pressure fluctuations. While the desurger 152 absorbs some pressure fluctuations, the desurger 152 and/or mud pump 116 also act as reflective devices. That is, pressure pulses propagating from the telemetry device 134 tend to reflect off the desurger 152 and/or mud pump 116, sometimes a negative reflection, and propagate back downhole. The reflections create interference that, in some cases, adversely affects the ability to determine the presence of the pressure pulses propagating from the telemetry device 134.

In addition to transmitting information collected downhole to the surface, telemetry module 134 may receive information from the surface over one or more of the above-described communication channels. The information received from the surface may include, for example, signals for controlling the operation of the BHA or individual components thereof. Such control signals may be used, for example, to update operating parameters of the BHA for purposes of adjusting a planned trajectory or path of wellbore 126 through the formation during different stages of the drilling operation. In one or more embodiments, the control signals may be representative of commands input by a well site operator for making adjustments to the planned path or controlling various operational variables of the drilling operation as downhole conditions change over time. As described above, such operational variables may include, but are not limited to, weight on bit, drilling fluid flow through the drill pipe, the drill string rotational speed, and the density and viscosity of the drilling fluid.

In one or more embodiments, computer 144 may provide an interface enabling the well site operator at the surface to receive indications of downhole operating conditions and controllable parameters and adjust one or more of the parameters accordingly. The interface may be include a display for presenting relevant information, e.g., values of drilling parameters or operational variables, to the operator during the drilling operation as well as a user input device (e.g., a mouse, keyboard, touch-screen, etc.) for receiving input from the operator. As downhole operating conditions may continually change over the course of the operation, the operator may use the interface provided by computer 144 to react to such changes in real time by adjusting selected drilling parameters in order to increase and/or maintain drilling efficiency and thereby, optimize the drilling operation.

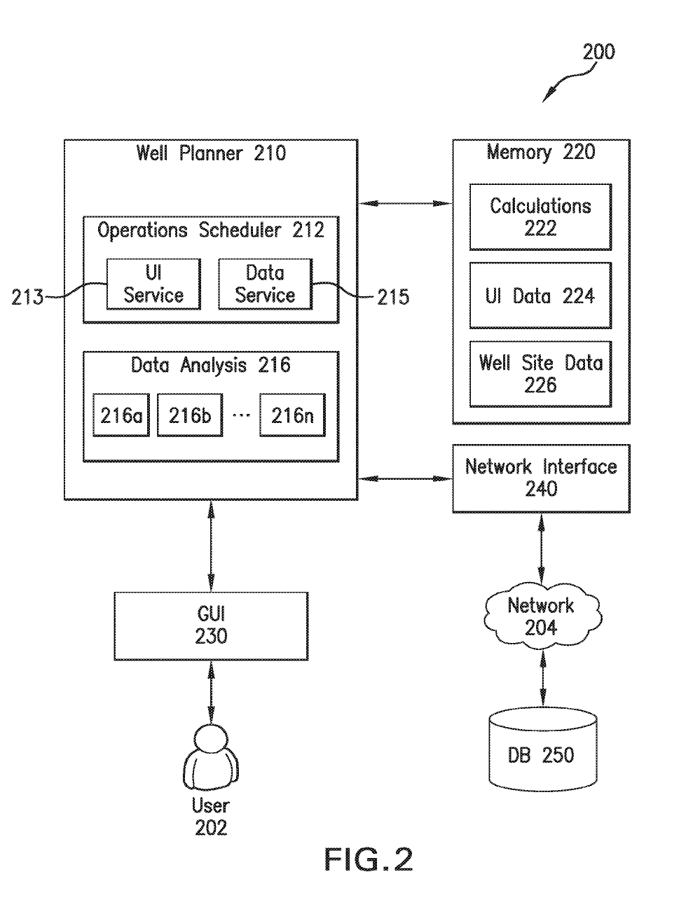

In one or more embodiments, the interface also may be used to provide recommended values for one or more operational parameters of interest to the well site operator for drilling wellbore 126 along the planned path over different stages of the drilling operation. Such recommendations may be provided by computer 144 or remote computer system coupled thereto, as described above, based on the results of data analysis performed during one or more stages of the drilling operation, as will be described in further detail below with respect to FIG. 2.

FIG. 2 is a block diagram of an illustrative system 200 for automated well planning and data analysis for downhole operations. As shown in FIG. 2, system 200 includes a well planner 210, a memory 220, a graphical user interface (GUI) 230, and a network interface 240. In one or more embodiments, well planner 210, memory 220, GUI 230, and network interface 240 may be communicatively coupled to one another via an internal bus of system 200. Although only well planner 210, memory 220, GUI 230, and network interface 240 are shown in FIG. 2, it should be appreciated that system 200 may include additional components, modules, and/or sub-components as desired for a particular implementation.

System 200 can be implemented using any type of computing device having at least one processor and a processor-readable storage medium for storing data and instructions executable by the processor. Examples of such a computing device include, but are not limited to, a mobile phone, a personal digital assistant (PDA), a tablet computer, a laptop computer, a desktop computer, a workstation, a server, a cluster of computers, a set-top box, or other type of computing device. Such a computing device may also include an input/output (I/O) interface for receiving user input or commands via a user input device (not shown). The user input device may be, for example and without limitation, a mouse, a QWERTY or T9 keyboard, a touch-screen, a graphics tablet, or a microphone. The I/O interface also may be used by the computing device to output or present information via an output device (not shown). The output device may be, for example, a display coupled to or integrated with the computing device for displaying a digital representation of the information being presented to time user. The I/O interface in the example shown in FIG. 2 may be coupled to GUI 230 for receiving input from a user 202 and displaying information and content to user 202 based on the received input. GUI 230 can be any type of GUI display coupled to system 200.

As will be described in further detail below, memory 220 can be used to store information accessible by well planner 210 and any of its components for implementing the functionality of the present disclosure. Memory 220 may be any type of recording medium coupled to an integrated circuit that controls access to the recording medium. The recording medium can be, for example and without limitation, a semiconductor memory, a hard disk, or similar type of memory or storage device. In some implementations, memory 220 may be a remote data store, e.g., a cloud-based storage location, communicatively coupled to system 200 over a network 204 via network interface 240. Network 204 can be any type of network or combination of networks used to communicate information between different computing devices. Network 204 can include, but is not limited to, a wired (e.g., Ethernet) or a wireless (e.g., Wi-Fi or mobile telecommunications) network. In addition, network 204 can include, but is not limited to, a local area network, medium area network, and/or wide area network such as the Internet.

In one or more embodiments, well planner 210 includes an operations scheduler 212 for generating a schedule of downhole operations to be performed along a planned path of a well (e.g., wellbore 126 of FIG. 1) within a subsurface formation. The downhole operation(s) may be at least one or any combination of the following: a drilling operation; a trip in operation; a trip out operation; a wiping operation; a drilling and rotating off bottom operation; or a production operation. The downhole operation(s) may be performed over a plurality of operating intervals along the planned well path. Each operating interval may be, for example, a depth or time range corresponding to a different stage of the operation to be performed along a portion of the planned well path.

In one or more embodiments, the number of operating intervals and size of each interval for such an operations schedule may be determined by operations scheduler 212 based on input received from a user 202 via GUI 230. In some implementations, the input from user 202 may be received via an input table provided by operations scheduler 212 for the operations schedule within a scheduler control panel of GUI 230. The rows of the input table may correspond to different operating intervals that can be defined by user 202. The columns of the table may correspond to different attributes that can be used to define each interval. Such attributes may include, for example, the start and end of each operating interval (e.g., start and end of the depth or time range) along with initial values of one or more operational variables for performing each operating interval. Examples of such operational variables include, but are not limited to, weight on bit (WOB), drill bit rotational speed, drilling fluid flow rate, bore diameter, bore cross sectional area, drilling fluid parameters, reamer/hole-opener diameter, and reamer/hole-opener cross sectional area. Thus, the operations schedule generated using operations scheduler 212 may provide a roadmap for performing the downhole operation using different sets of operational variables over the plurality of operating intervals along the planned well path.

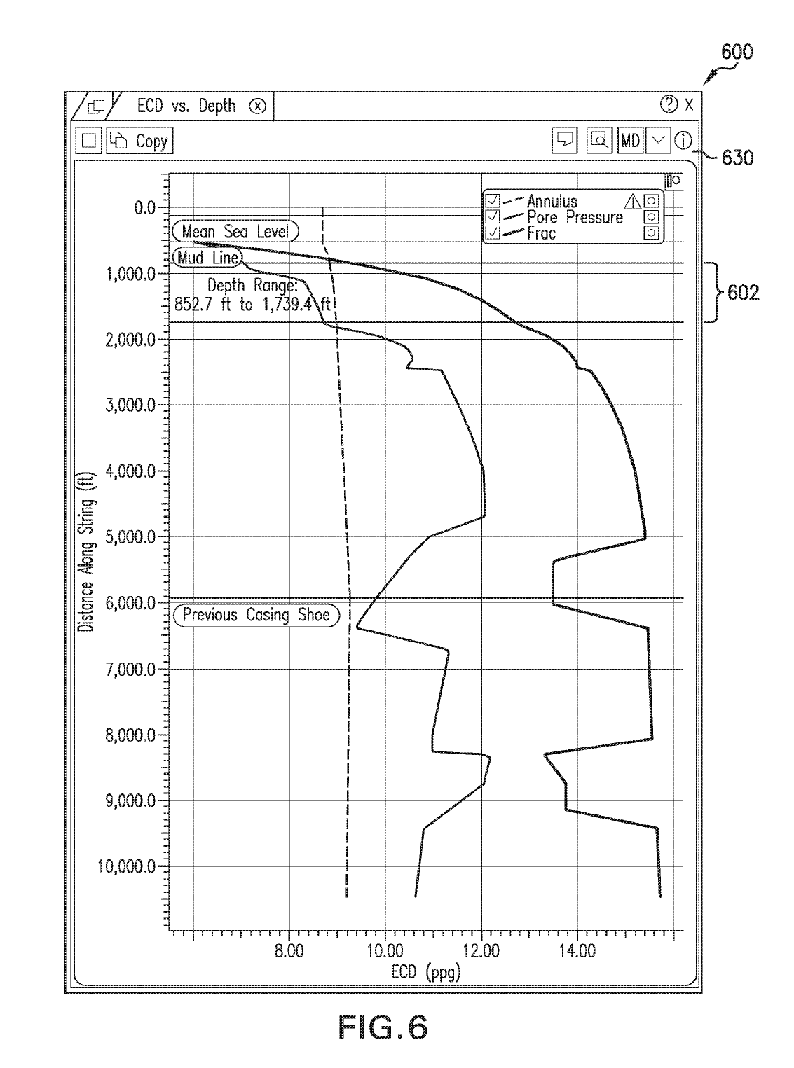

In one or more embodiments, the operational variables for each interval may be selected by user 202 from a list of available operational variables provided by operations scheduler 212 within a variable selection control panel of GUI 230. An example of such a selection control panel is shown in FIG. 6 and will be described in further detail below. In one or more embodiments, the selected operational variables for each operating interval may be part of a set of operational variables used to calculate an optimization parameter. The optimization parameter may be selected by user 202 for analyzing a particular aspect of the downhole operation for purposes of planning and optimizing the well path over different stages (or operating intervals) of the operation.

As will be described in further detail below, values of the optimization parameter may be calculated for different points along the planned well path, based on the values of the associated operational variables at those points. A two-dimensional (2D) or three-dimensional (3D) graphical representation of the calculated values may then be displayed via an interactive content output visualization panel within GUI 230. The displayed graphical representation may be, for example, a plot graph with trend lines representing the expected and actual values of the optimization parameter over each of the plurality of operating intervals along the planned well path. The plot graph may be displayed with boundary lines indicating the start and end of each operating interval. User 202 may interact with the plot graph via GUI 230 to define the boundaries of new operating intervals at selected points of interest along the planned well path or adjust the boundaries of any previously defined intervals. User 202 may also calibrate the operational variables for one or more of the operating intervals such that the expected values of the optimization parameter more closely align with the actual measured values. Alternatively, the operating intervals and associated operational variables may be dynamically updated based on real-time data acquired from the well site as the downhole operation is implemented along the planned well path.

In one or more embodiments, the values of the optimization parameter may be calculated as part of a data analysis 216 performed by well planner 210. As shown in FIG. 2, well planner 210 may include a plurality of data analysis units 216a through 216n (or “data analysis units 216a-n,” collectively) for performing various types of engineering analyses related to different aspects of the downhole operation. For example, each of data analysis units 216a-n may be used to perform a different one of these various types of data analyses provided by well planner 210. Examples of such analyses include, but are not limited to, torque and drag analysis, hydraulic analysis, swab and surge analysis, well control, casing centralization placement, BHA dynamics, and stuck pipe analysis. Examples of optimization parameters that relate to one or more of these analyses include, but are not limited to, equivalent circulating density (ECD), circulating pressure, rate of penetration (ROP), specific energy, hook load, tension, torque, and side force. While only data analysis units 216a-n are shown in FIG. 2, it should be appreciated that embodiments are not intended to be limited thereto and that any number of data analysis units may be used for performing any number of different types of data analyses related to well engineering and downhole operations, as desired for a particular implementation. Further, while the automated well planning and data analysis functionality of the present disclosure will be described herein with reference to “data analysis units 216a-n” as a whole, it should be appreciated that embodiments may be applied to individual data analysis units as needed or desired for a particular implementation.

In one or more embodiments, the analysis performed by each of data analysis units 216a-n may include modeling aspects of the downhole operation that relate to the particular type of analysis being performed. For example, data analysis unit 216a may perform a hydraulic analysis in which fluid flow in the well and/or surrounding formation is modeled. In some implementations, each of data analysis units 216a-n may perform a set of calculations using a predetermined engineering model to simulate conditions in the well related to the particular aspect of the downhole operation being analyzed. Thus, the hydraulic analysis performed by data analysis unit 216a in the above example may include performing a set of engineering calculations based on a predetermined rheological model to simulate pressure and temperature changes across the pipe string and/or annular space in the well. The results of the simulation may be used to estimate values of the operational variables associated with the optimization parameter selected by user 202. The estimated values of the operational variables may then be used to calculate expected values of the optimization parameter for each of the operating intervals along the planned path of the well. The calculations results, including the estimated values of the operational variables, may be stored within memory 220 as calculations 222.

In one or more embodiments, the modeling and simulation performed by each of data analysis units 216a-n to estimate the values of the operational variables may be based on data acquired for the downhole operation from various sources. One such data source may be, for example, a local data file (e.g., corresponding to well site data 226) that is stored in memory 220 or other computer-readable storage medium (not shown) coupled to system 200. Such a computer-readable storage medium may be, for example, a hard disk or other type of permanent storage device. Another data source may be a remote data store or database (not shown), e.g., a cloud-based storage system, communicatively coupled to well planner 210 and other components of system 200 via network 204 and network interface 240. The remote data store may be, for example, a centralized data warehouse or repository for storing historical well site data for later access and retrieval by system 200. Such data may include well site data produced during similar downhole operations conducted at one or more nearby offset wells. The data acquired from the remote data source may be stored in memory 220 as well site data 226.

In one or more embodiments, the acquired data may include formation property measurements collected in real-time by a downhole tool (e.g., downhole tool 132 of FIG. 1, as described above) during an implementation phase of the downhole operation in this example. For example, the estimated values of the one or more operational variables may be provided as control inputs to a well site control system (e.g., computer 144) for implementing a current one of the plurality of operating intervals of the downhole operation at the well site. Such inputs may be used to control the direction and orientation of a geosteering tool for drilling the well along a portion of the planned path corresponding to a current one of the plurality of operating intervals of the operation. As the operation is implemented along the planned well path, data may be collected by a downhole tool (e.g., downhole tool 132 of FIG. 1, as described above). Such data may include, for example and without limitation, formation property measurements and other data related to the downhole operation in progress.

In one or more embodiments, the information collected at the well site may be transmitted by time well site control system to system 200 via network 204. However, it should be appreciated that embodiments are not limited thereto and that the automated well planning and data analysis functionality provided by system 200 as described herein may be implemented as part of the well site control system itself. In some implementations, the well site data in this example may be transmitted in real-time using an industrial data format, for example, the wellsite information transfer standard markup language (WITSML) or other extensible markup language (XML) based format. The real-time data received by data analysis units 216a-n for the current operating interval may be used to calculate actual values of the optimization parameter at different points along the corresponding portion of the planned well path.

In one or more embodiments, data analysis units 216a-n may check for any indications of changed conditions in the well by comparing the actual values of the optimization parameter calculated at these points with the corresponding expected values calculated previously. A significant variation (e.g., exceeding a predetermined tolerance threshold) between the actual and expected optimization parameter values calculated for a particular point along the planned well path may indicate the presence of a critical condition in the well that may affect the outcome of the downhole operation at that point. In response to receiving an indication of such a condition along the planned well path during the current operating interval, data analysis units 216a-n may update one or more subsequent operating intervals to be performed following the current operating interval. In some implementations, data analysis units 216a-n may automatically define new operating intervals or update previously defined intervals such that interval boundaries overlap such parameter variations. In some implementations, the operating intervals may be defined according to a variable step size, e.g., a variable depth range, which can be adjusted based on critical conditions in the well that have been detected at various points, e.g., at various depths, along the planned well path. For example, when the presence of such a condition has been detected at a location along the planned well path, the step size may be reduced in order to increase the number of data points and operating intervals for the remainder of the planned well path after that location. In one or more embodiments, the step size may be specified by user 202 via a corresponding input data field provided within the scheduler control panel associated with operations scheduler 212.

In one or more embodiments, data analysis units 216a-n may also update the predetermined model for simulating conditions in the well and use the updated model to update the estimated values for the operational variables. The updated operational variable estimates may then be used to calculate the expected values of the optimization parameter for the subsequent operating intervals. Further, the updated operational variables may be provided as new control inputs to the geosteering tool for purposes of adjusting the planned path of the well for one or more subsequent operating intervals of the drilling operation.

In one or more embodiments, one or more of the above-described data sources may be specified by user 202 via an input control panel associated with the particular type of analysis being performed within GUI 230. For example, user 202 may specify a location of the local file or remote storage location via a dedicated input control panel provided within GUI 230 for a particular one of data analysis units 216a-n. In some implementations, GUI 230 may include a plurality of input control panels corresponding to data analysis units 216a-n. The input control panels may be displayed as, for example, separate tabbed windows that may be individually resized and arranged within an input control and content viewing area of GUI 230. Another tabbed window may be displayed for the scheduler control panel associated with operations scheduler 212 alongside the tabbed windows for the input control panels associated with data analysis units 216a-n within the same content viewing area. Each data analysis input control panel may include various input data fields that user 202 may use to specify different analysis settings and operational constraints for the analysis to be performed. Examples of such user-specified constraints include, but are not limited to, a minimum flow rate, one or more formation pressures, a minimum weight for buckling, and a directional profile for the planned path or trajectory of the well within the formation.

In one or more embodiments, an output visualization panel may also be displayed within the content viewing area of GUI 230 for each of data analysis units 216a-n to present results of the analysis performed by each data analysis unit. Each output visualization panel may be used to display, for example, a plot graph showing expected and/or actual values of the optimization parameter calculated by a particular data analysis unit over different operating intervals along the planned well path, as described above.

In one or more embodiments, the results of the data analysis performed by one or more of data analysis units 216a-n may also be used to automatically update the operating intervals and associated operational variables of the operations schedule for the downhole operation, e.g., the rows and columns of the input table as displayed within the scheduler control panel associated with operations scheduler 212 as described above. In this way, the input table may also function as an output table with respect to values of the operational variables for each operating interval of the operations schedule. Furthermore, this allows the scheduler control panel associated with operations scheduler 212 to function as a global input/output control panel with respect to each of data analysis units 216a-n.

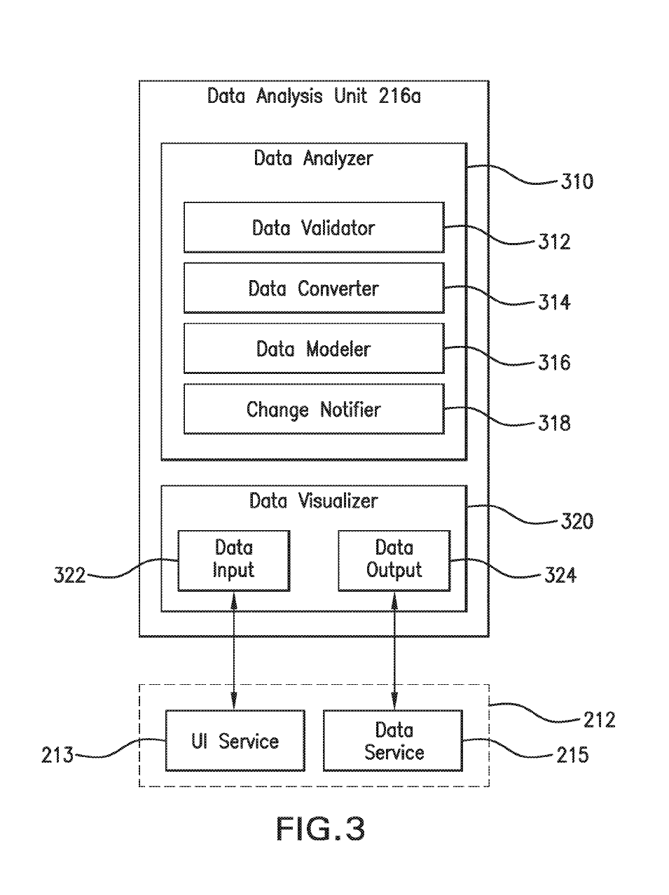

In one or more embodiments, operations scheduler 212 may provide a UI service 213 and a data service 215 to which each of data analysis units 216a-n may subscribe for exchanging information relating to the inputs and outputs of the operations schedule, respectively. For example, each of data analysis units 216a-n may use UI service 213 for sending and receiving UI control information to and from operations scheduler 212 for a set of operational variables within the input table. Such UI control information may be stored in memory 220 as UT data 224. Similarly, data service 215 may be used to send and receive information related to the values of the operational variables for one or more operating intervals. Additional details regarding the communication between data analysis units 216a-n and operations scheduler 212 will be described below with respect to FIG. 3.

FIG. 3 is a block diagram illustrating an example of a data analysis unit 300. Data analysis unit 300 may be used, for example, to implement any of data analysis units 216a-n of FIG. 2, as described above. As shown in FIG. 3, data analysis unit 300 includes a data analyzer 310 for performing the data analysis as described above. Data analysis unit 300 also includes a data visualizer 320 for presenting results of the analysis, e.g., via an associated output visualization panel displayed within a content viewing area of GUI 230 of FIG. 2, as described above.

In one or more embodiments, data analyzer 310 includes a data validator 312, a data converter 314, a data modeler 316, and a change notifier 318. Data validator 312 may be used to validate any user input received for one or more operational variables selected by the user along with the optimization parameter related to the type of analysis performed by data analysis unit 300. In one or more embodiments, any user input validated by data validator 312 may be provided along with other input data (e.g., well site data 226 of FIG. 2, as described above) to data modeler 316. Data modeler 316 may apply the input data to, for example, a predetermined engineering model for simulating conditions in the well related to the type of analysis being performed. In some implementations, data modeler 316 may use the input data to generate a new model or update the predetermined model in order to optimize or improve the accuracy of the simulation results. The results of the modeling and simulation performed by data modeler 316 may be used to estimate values of the operational variables and then use the estimated values to calculate expected values of the associated optimization parameter for each of the operating intervals along the planned path of the well. In one or more embodiments, data modeler 316 may use a separate computational model for calculating values of the optimization parameter based on the values of associated operational variables. The operational variables associated with the optimization parameter may serve, for example, as input parameters of such a computational model. Thus, the values of the operational variables estimated for a particular point along the well path may be applied as inputs to the computational model in order to calculate an expected value of the optimization parameter at that point.

In one or more embodiments, data visualizer 320 may provide a visualization of the expected optimization parameter values along the planned path of the well within the associated output visualization panel. Additionally, a data output unit 324 of data visualizer 320 may provide the estimated values of the operational variables to operations scheduler 212 of FIG. 2 via data service 215. As described above, the estimated values may then be used to update the initial values of the operational variables specified by the user for one or more of the operating intervals within the input table for the operations schedule provided by operations scheduler 212.

In one or more embodiments, data visualizer 320 may include a data input unit 322 for specifying to operations scheduler 212 via UI service 213 information for certain operational variables to be included in the list of available operational variables for the input table. As described above, the list of available variables may appear as user-selectable options for enabling corresponding columns within the input table via the variable selection control panel. Accordingly, operations scheduler 212 may use the information received from data input unit 322 via service 213 to display a user-selectable option for each specified operational variable within the variable selection control panel and a column within the input table for each operational variable once selected or enabled by the user via the variable selection control panel. The specified information from data input unit 322 may include, for example, a name or identifier associated with each operational variable along with UI control information. The UI control information may include details related to the visual layout and appearance of the corresponding column and UI control elements to be displayed by operations scheduler 212 for that operational variable within the input table. The UI control information may also include domain logic for control and validation of the type of input that the user may enter for a particular operational variable, e.g., via a text data field or other type of UI control element displayed within cells of the input table for that operational variable.

In one or more embodiments, change notifier 318 may notify operations scheduler 212 of any changes or updates to any of the operating intervals or the estimated value of an operational variable used to calculate the optimization parameter for each interval. The notification may be sent to operations scheduler 212 via, for example, data service 215. Such changes may be based on results of the data analysis performed by data analysis unit 300, for example, results indicating a changed condition in the well based on a significant variation between expected and actual values of the optimization parameter, as described above. Such changes may also be based on input received from the user via an input control panel associated with data analysis unit 300 within a content viewing area of GUI 230 of FIG. 2 as described above.

In response to the notification received, operations scheduler 212 also may send notifications of the changed condition via data service 215 to one or more other data analysis units. The changed condition may require each notified data analysis unit to perform further analysis and recalculate the value of the optimization parameter. Referring back to FIG. 2, operations scheduler 212 may also use UI service 213 to notify one or more of data analysis units 216a-n of a changed condition relating to one or more operational variables based on input received from the user via the input table.

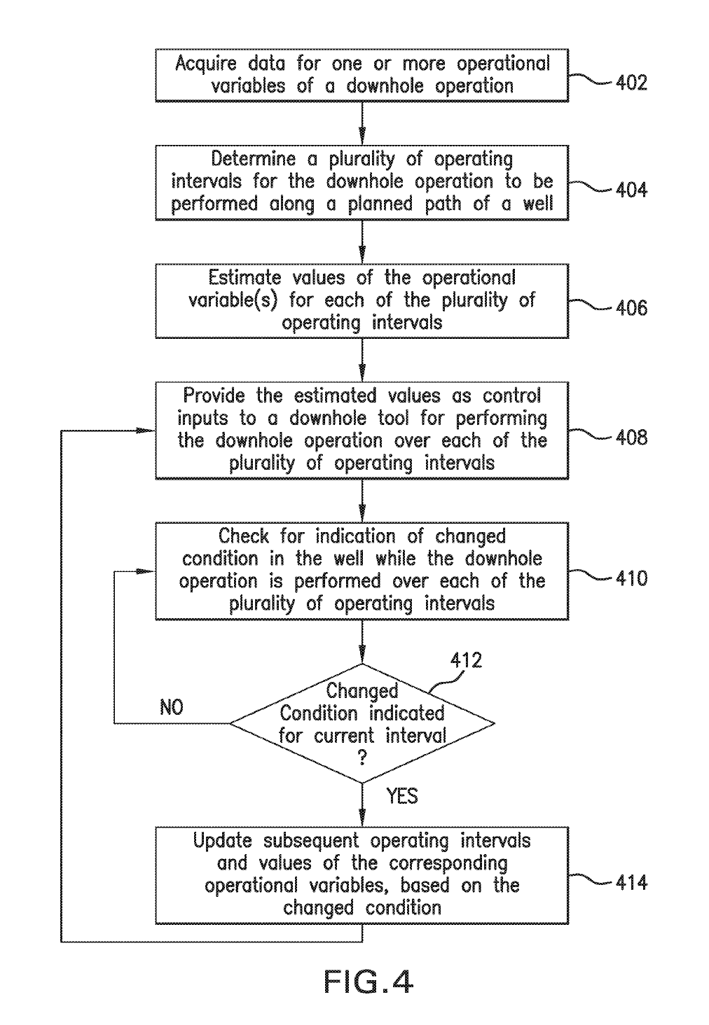

FIG. 4 is a flowchart of an illustrative process 400 for automating well planning and data analysis for drilling operations. For purposes of explanation and discussion, process 400 will be described using system 200 of FIG. 2, as described above. However, process 400 is not intended to be limited thereto. The operations corresponding to blocks 402, 404, 406, 408, 410, 412, and 414 of process 400 may be performed by, for example, well planner 210 of system 200, as described above.

As shown in FIG. 4, process 400 begins at block 402, which includes acquiring data for one or more operational variables of a downhole operation to be performed at a well site. The downhole operation may be, for example, a drilling operation in which the well is drilled along a planned path through a subsurface formation at the well site. Block 404 includes determining a plurality of operating intervals for the downhole operation to be performed along the planned path of the well. As described above, each operating interval may be a depth or time range over which the downhole operation may be performed along a portion of the planned well path. At block 406, values of the operational variable(s) for each of the plurality of operating intervals may be estimated. The values may be estimated based on the data acquired at block 402. In one or more embodiments, block 406 may include using historical well site data acquired at block 402 to perform a simulation of the downhole operation along the planned path of the well through the formation and then estimating the operational variable values based on results of the simulation.

The estimated values of the operational variable(s) may then be provided at block 408 as control inputs to a control system at the well site for implementing or performing the downhole operation over each of the plurality of operating intervals along the planned well path. Process 400 may then proceed to block 410, which includes checking for any indication of a changed condition in the well while the downhole operation is performed over each of the plurality of operating intervals

If no indication of a changed condition is received at block 412 for the current interval, process 400 returns to block 410 in which any indication of a changed condition is checked for the next operating interval in the plurality of operating intervals determined for the downhole operation. However, if an indication of a changed condition is received at block 412 for the current interval, process 400 proceeds to block 414, in which subsequent operating intervals of the downhole operation and corresponding values of operational variables estimated for the intervals are updated based on the changed condition. Process 400 then returns to block 410 in order to repeat the checking of changed conditions for any remaining operating intervals to be performed.

In one or more embodiments, process 400 and the functions performed by well planner 210 and its components, including operations scheduler 212 and data analysis units 216a-n, as described above with respect to FIGS. 2 and 3, may be implemented as part of a computer application for well engineering. For example, operations scheduler 212 and data analysis units 216a-n may be implemented as separate plug-ins of such a well engineering application. The well engineering application may be executable at, for example, a computing device of a user (e.g., a well operator) for purposes of planning and optimizing a downhole operation at a well site. The computing device may be, for example, a surface computing device located at the well site itself (e.g., using computer 144 of FIG. 1, as described above). Alternatively, the computing device may be a computing device that is located away from the well site and that is configured to remotely monitor and control well site operations through communications with well site computing devices via a network (e.g., network 204 of FIG. 2, as described above).

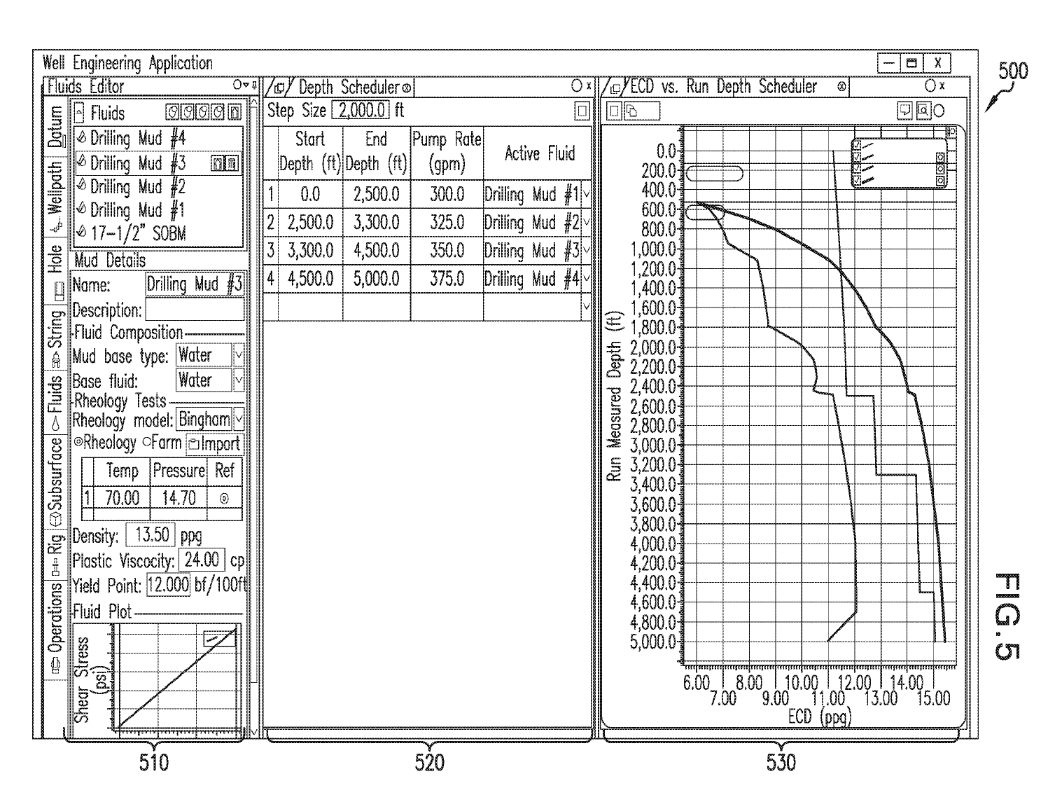

The well engineering application in this example may include a GUI for providing the automated well planning and data analysis functionality described herein. The GUI may allow the user to, for example, define operating intervals (e.g., depth or time ranges) corresponding to different stages of the downhole operation to be performed at the well site. Alternatively, the operating intervals may be defined automatically based on the results of data analysis performed by the well engineering application. An example of such a GUI will now be described using FIGS. 5-8.

FIG. 5 is a view of an illustrative GUI 500 of a well engineering application for automated well planning and data analysis for a downhole operation as described above. The downhole operation in this example may be a drilling operation for drilling a well along a planned path within a subsurface formation. However, it should be appreciated that embodiments of the present disclosure are not limited thereto and that the disclosed embodiments may be applied to other types of downhole operations. As shown in FIG. 5, GUI 500 may include an input control and content viewing area including different control panels related to a hydraulic analysis performed by the well engineering application for the drilling operation. However, it should be appreciated that the disclosed embodiments may be applied to any of various types of data analyses.

In particular, GUI 500 includes an input control panel 510, a scheduler control panel 520, and an output visualization panel 530. A user of the well engineering application in this example may interact directly with input control panel 510 to specify different settings for the hydraulic analysis. Examples of such analysis settings may include, but are not limited to, type of drilling fluid (or mud), fluid composition type, and type of theological model. Scheduler control panel 520 may include an input table that the user can use to define new operating intervals for the drilling operation (e.g., using rows of the input table) along with various attributes for each interval (e.g., using columns of the input table). As described above, such attributes may include, for example, the start and end of each operating interval (e.g., start and end of each depth range) along with initial values of one or more operational variables (e.g., pump rate and active fluid type) for each operating interval. While the operating intervals shown in FIG. 5 are depth intervals, it should be appreciated that embodiments of the present disclosure are not limited thereto and that embodiments may be applied to other types of operating intervals, e.g., time intervals in the form of a different time range for each interval of the operation. Output visualization panel 530 may be an interactive content visualization panel for displaying the results of the hydraulic analysis in this example. The displayed graphical representation may be, for example, a plot graph with trend lines representing the expected and actual values of a selected optimization parameter (e.g., ECD) over each of the plurality of operating intervals (e.g., depth ranges) along the planned well path.

Another example of such an output visualization panel is shown in FIG. 6. In FIG. 6, an output visualization panel 630 is shown within a portion of a GUI 600. Output visualization panel 630 is used to display a plot graph in the form of an ECD vs. run depth plot graph with separate plot lines representing the annulus, pore pressure, and fracture gradient. The plot graph is displayed with boundary lines indicating the start and end of an operating interval or depth range 602. The user may interact directly with the plot graph as displayed within output visualization panel 630 to adjust start or end of depth range 602 or to define the boundaries of additional depth ranges at selected points of interest along the planned well path.

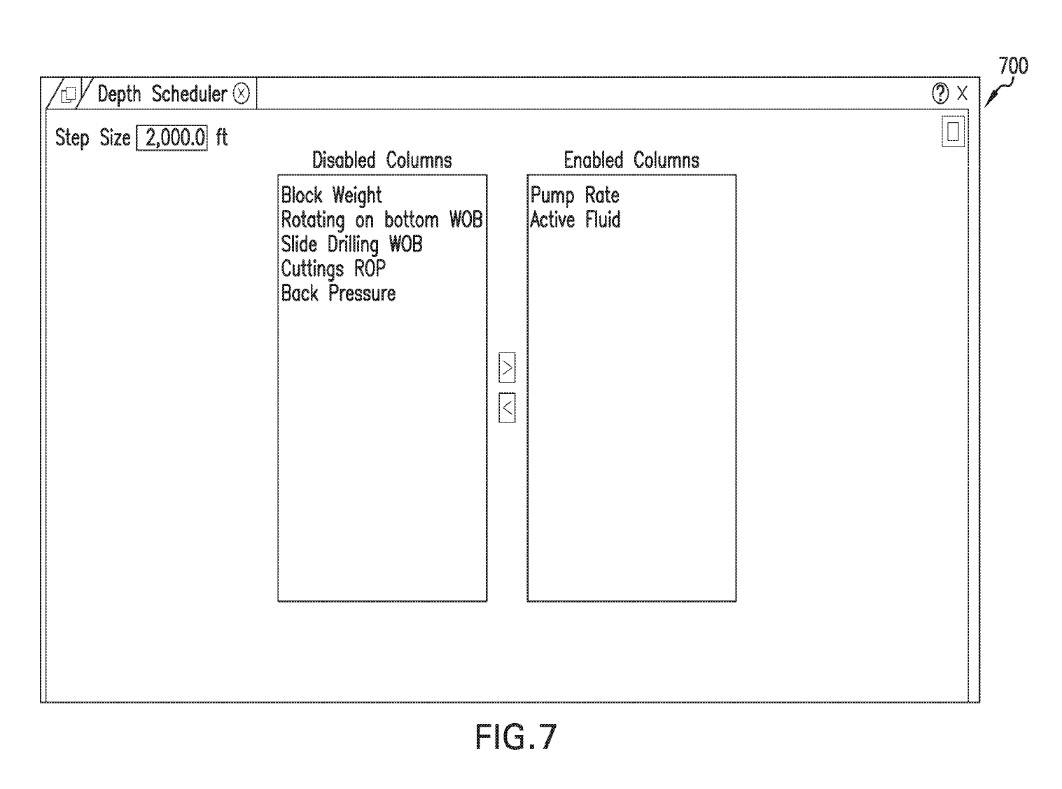

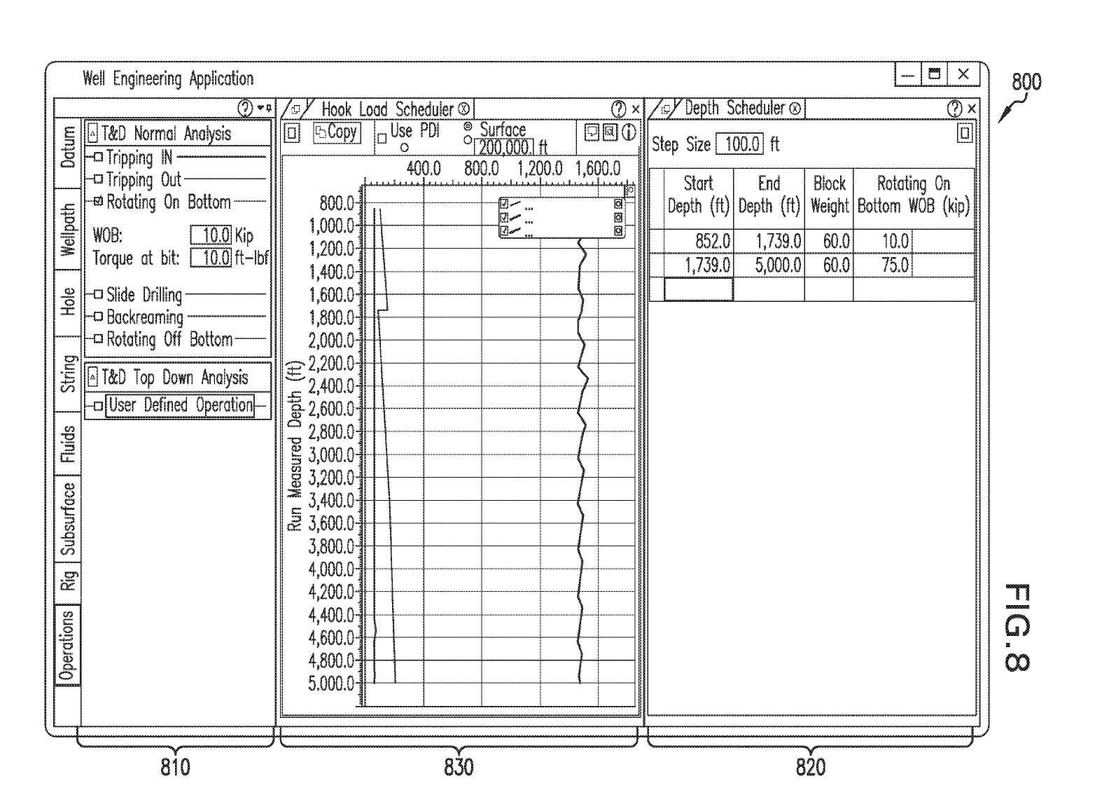

Referring back to FIG. 5, the columns of the input table shown within scheduler control panel 520 may correspond to operational variables selected by the user via a selection control panel. FIG. 7 is a diagram illustrating an example of a selection control panel 700 that may be displayed within GUI 500 for enabling columns of the input table corresponding to selected operational variables associated with the data analysis to be performed. As shown in FIG. 7, the enabled columns may correspond to the “pump rate” and “active fluid” operational variables for the hydraulic analysis in the example described above. In another example, the user may select a different set of operational variables to enable columns of the input table for a different type of data analysis. For example, the user may select “block weight” and “rotating on bottom WOB” variables to enable input table columns for a torque and drag analysis, as shown in FIG. 8.

FIG. 8 is an illustrative view of a GUI 800 of the well engineering application including an input control and content viewing area for a torque and drag analysis. GUI 800 includes an input control panel 810, a scheduler control panel 820, and an output visualization panel 830 that are similar to input control panel 510, scheduler control panel 520, and output visualization panel 530 of GUI 500 of FIG. 5, as described above. However, unlike GUI 500 of FIG. 5, the information within the panels of GUI 800 pertains to a torque and drag analysis instead of a hydraulic analysis. Also, scheduler control panel 820 and output visualization panel 830 are shown in a different arrangement within GUI 800 relative to the corresponding panels as shown in GUI 500.

It should be appreciated that scheduler control panel 520 of GUI 500 in FIG. 5 and scheduler control panel 820 of GUI 800 in FIG. 8 may each be associated with an operations scheduler (e.g., operations scheduler 212 of FIG. 2, as described above) of the well engineering application and that the remaining input control panels and output visualization panels of the GUIs in FIGS. 5 and 8 may be associated with separate data analysis units (e.g., data analysis units 216a-n of FIG. 2, as described above) for performing a hydraulic analysis and a torque and drag analysis, respectively. While the examples shown in FIGS. 5-8 are described in the context of different GUIs, it should also be appreciated that the input control and output visualization panels associated with the operations scheduler and the individual data analysis units may be implemented as separate tabbed windows that may be individually resized and arranged as desired by the user within the same content viewing area of a single GUI provided for the well engineering application.

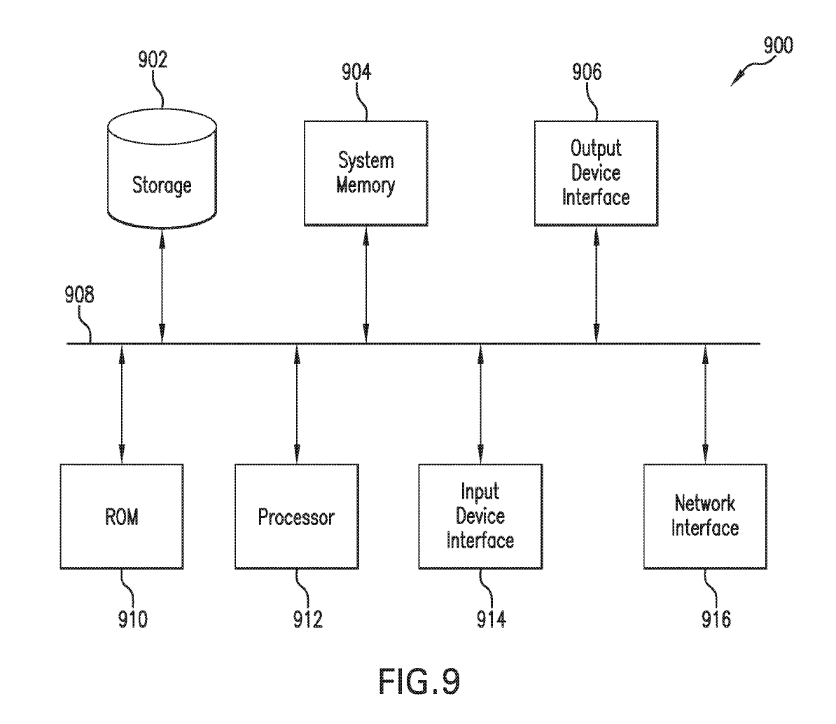

FIG. 9 is a block diagram of an exemplary computer system 900 in which embodiments of the present disclosure may be implemented. For example, system 200 of FIG. 2, as described above, and process 400 of FIG. 4, as described above, may be implemented using system 900. System 900 can be a computer, phone, PDA, or any other type of electronic device. Such an electronic device includes various types of computer readable media and interfaces for various other types of computer readable media. As shown in FIG. 9, system 900 includes a permanent storage device 902, a system memory 904, an output device interface 906, a system communications bus 908, a read-only memory (ROM) 910, processing unit(s) 912, an input device interface 914, and a network interface 916.

Bus 908 collectively represents all system, peripheral, and chipset buses that communicatively connect the numerous internal devices of system 900. For instance, bus 908 communicatively connects processing unit(s) 912 with ROM 910, system memory 904, and permanent storage device 902.

From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of system 900. Permanent storage device 902, on the other hand, is a read-and-write memory device. This device is a non-volatile memory unit that stores instructions and data even when system 900 is off. Some implementations of the subject disclosure use a mass-storage device (such as a magnetic or optical disk and its corresponding disk drive) as permanent storage device 902.

Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such a random access memory. System memory 904 stores some of the instructions and data that the processor needs at runtime. In some implementations, the processes of the subject disclosure are stored in system memory 904, permanent storage device 902, and/or ROM 910. For example, the various memory units include instructions for computer aided pipe string design based on existing string designs in accordance with some implementations. From these various memory units, processing unit(s) 912 retrieves instructions to execute and data to process in order to execute the processes of some implementations.

Bus 908 also connects to input and output device interfaces 914 and 906. Input device interface 914 enables the user to communicate information and select commands to the system 900. Input devices used with input device interface 914 include, for example, alphanumeric, QWERTY, or T9 keyboards, microphones, and pointing devices (also called “cursor control devices”). Output device interfaces 906 enables, for example, the display of images generated by the system 900. Output devices used with output device interface 906 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 9, bus 908 also couples system 900 to a public or private network (not shown) or combination of networks through a network interface 916. Such a network may include, for example, a local area network (“LAN”), such as an Intranet, or a wide area network (“WAN”), such as the Internet. Any or all components of system 900 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, process 400 of FIG. 4, as described above, may be implemented using system 900 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, embodiments of the present disclosure are particularly useful for automated well planning and data analysis for downhole operations. In one or more embodiments of the present disclosure, a computer-implemented method for automating well planning and data analysis for downhole operations includes: receiving input from a user selecting an optimization parameter of interest for a downhole operation to be performed over a plurality of operating intervals along a planned path of a well within a subsurface formation; estimating values of one or more operational variables for each of the plurality of operating intervals, based on the selected optimization parameter; providing the estimated values of the one or more operational variables as inputs to a downhole tool for performing the downhole operation over a current one of the plurality of operating intervals along the planned path of the well; responsive to receiving an indication that a condition in the well has changed while the downhole operation is performed during the current operating interval, updating subsequent operating intervals following the current operating interval along with the estimated values of the one or more operational variables for each of the subsequent operating intervals; and adjusting the planned path of the well by providing the updated values of the one or more operational variables as inputs to the downhole tool for performing the downhole operation over the one or more subsequent operating intervals. Further, a computer-readable storage medium with instructions stored therein has been described, where the instructions when executed by a computer cause the computer to perform a plurality of functions, including functions to: receive input from a user selecting an optimization parameter of interest for a downhole operation to be performed over a plurality of operating intervals along a planned path of a well within a subsurface formation; estimate values of one or more operational variables for each of the plurality of operating intervals, based on the selected optimization parameter; provide the estimated values of the one or more operational variables as inputs to a downhole tool for performing the downhole operation over a current one of the plurality of operating intervals along the planned path of the well; receive an indication that a condition in the well has changed while the downhole operation is performed during the current operating interval; responsive to the receipt of the indication, update subsequent operating intervals following the current operating interval along with the estimated values of the one or more operational variables for each of the subsequent operating intervals; and adjust the planned path of the well by providing the updated values of the one or more operational variables as inputs to the downhole tool for performing the downhole operation over the one or more subsequent operating intervals.

For the foregoing embodiments, each operating interval may be a time range corresponding to a different stage of the downhole operation to be performed along a portion of the planned path of the well. Alternatively, each operating interval may be a depth range corresponding to a portion of the well along the planned path within the subsurface formation. The estimating of values of one or more operational variables may include: acquiring data for the one or more operational variables from one or more data sources associated with the downhole operation; estimating values of one or more operational variables for each of the plurality of operating intervals, based on the acquired data; and calculating expected values of an optimization parameter at predetermined points along a portion of the planned path of the well corresponding to the current operating interval, based on the estimated values of the one or more operational variables.

Further, such embodiments may further include any one of the following functions, operations or elements, alone or in combination with each other: calculating actual values of the optimization parameter along the portion of the planned path of the well, based on downhole data collected from the well as the downhole operation is implemented during the current operating interval; and comparing each of the expected values of the optimization parameter with a corresponding one of the actual values of the optimization parameter calculated at each of the predetermined points, wherein the indication of the changed condition in the well is received when a variation between the actual values and the expected values of the optimization parameter at one or more of the predetermined points is determined from the comparison to exceed a predetermined tolerance threshold. In the foregoing embodiments, the downhole tool may be a geosteering tool for drilling the well along the planned path, and the downhole data is measured in real-time by one or more sensors coupled to the geosteering tool during the current operating interval of the downhole operation along the portion of the planned path of the well. The foregoing embodiments may further include providing, within a graphical user interface (GUI) of a well engineering application executable at a computing device of a user, a visual representation of the expected values and the actual values of the optimization parameter calculated for each of the plurality of operating intervals along the planned path of the well. The subsequent operating intervals may be automatically updated based on the variation between the actual values and the expected values of the optimization parameter at the one or more of the predetermined points.

Likewise, a system for automating well planning and data analysis for downhole operations includes at least one processor and a memory coupled to the processor that has instructions stored therein, which when executed by the processor, cause the processor to perform functions, including functions to: receive input from a user selecting an optimization parameter of interest for a downhole operation to be performed over a plurality of operating intervals along a planned path of a well within a subsurface formation; estimate values of one or more operational variables for each of the plurality of operating intervals, based on the selected optimization parameter; provide the estimated values of the one or more operational variables as inputs to a downhole tool for performing the downhole operation over a current one of the plurality of operating intervals along the planned path of the well; receive an indication that a condition in the well has changed while the downhole operation is performed during the current operating interval; responsive to the receipt of the indication, update subsequent operating intervals following the current operating interval along with the estimated values of the one or more operational variables for each of the subsequent operating intervals; and adjust the planned path of the well by providing the updated values of the one or more operational variables as inputs to the downhole tool for performing the downhole operation over the one or more subsequent operating intervals.

In one or more embodiments of the foregoing system, each operating interval may be a time range or a depth range corresponding to a different stage of the downhole operation to be performed along a portion of the planned path of the well. Further, the functions performed by the processor may further include, either alone or in combination with each other, function to: acquire data for the one or more operational variables from one or more data sources associated with the downhole operation; estimate values of one or more operational variables for each of the plurality of operating intervals, based on the acquired data; calculate expected values of an optimization parameter at predetermined points along a portion of the planned path of the well corresponding to the current operating interval, based on the estimated values of the one or more operational variables; calculate actual values of the optimization parameter along the portion of the planned path of the well, based on downhole data collected from the well as the downhole operation is implemented during the current operating interval; compare each of the expected values of the optimization parameter with a corresponding one of the actual values of the optimization parameter calculated at each of the predetermined points, wherein the indication of the changed condition in the well is received when a variation between the actual values and the expected values of the optimization parameter at one or more of the predetermined points is determined from the comparison to exceed a predetermined tolerance threshold; and provide, within a graphical user interface (GUI) of a well engineering application executable at a computing device of a user, a visual representation of the expected values and the actual values of the optimization parameter calculated for each of the plurality of operating intervals along the planned path of the well. The downhole tool may be a geosteering tool for drilling the well along the planned path, and the downhole data is measured in real-time by one or more sensors coupled to the geosteering tool during the current operating interval of the downhole operation along the portion of the planned path of the well. The subsequent operating intervals may be automatically updated based on the variation between the actual values and the expected values of the optimization parameter at the one or more of the predetermined points.

While specific details about the above embodiments have been described, the above hardware and software descriptions are intended merely as example embodiments and are not intended to limit the structure or implementation of the disclosed embodiments. For instance, although many other internal components of the system 900 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A method of automating well planning and data analysis for downhole operations, the method comprising:
receiving input from a user selecting an optimization parameter of interest for a downhole operation to be performed over a plurality of operating intervals along a planned path of a well within a subsurface formation;
estimating values of one or more operational variables for each of the plurality of operating intervals, based on the selected optimization parameter;
providing the estimated values of the one or more operational variables as inputs to a downhole tool for performing the downhole operation over a current one of the plurality of operating intervals along the planned path of the well;
responsive to receiving an indication that a condition in the well has changed while the downhole operation is performed during the current operating interval, updating subsequent operating intervals following the current operating interval along with the estimated values of the one or more operational variables for each of the subsequent operating intervals; and
adjusting the planned path of the well by providing the updated values of the one or more operational variables as inputs to the downhole tool for performing the downhole operation over the one or more subsequent operating intervals.

2. The method of claim 1, wherein each operating interval is a time range corresponding to a different stage of the downhole operation to be performed along a portion of the planned path of the well.

3. The method of claim 1, wherein each operating interval is a depth range corresponding to a portion of the well along the planned path within the subsurface formation.

4. The method of claim 1, wherein estimating comprises:
acquiring data for the one or more operational variables from one or more data sources associated with the downhole operation; and
estimating values of one or more operational variables for each of the plurality of operating intervals, based on the acquired data.

5. The method of claim 4, wherein estimating further comprises:
calculating expected values of an optimization parameter at predetermined points along a portion of the planned path of the well corresponding to the current operating interval, based on the estimated values of the one or more operational variables.

6. The method of claim 5, further comprising:
calculating actual values of the optimization parameter along the portion of the planned path of the well, based on downhole data collected from the well as the downhole operation is implemented during the current operating interval; and
comparing each of the expected values of the optimization parameter with a corresponding one of the actual values of the optimization parameter calculated at each of the predetermined points,
wherein the indication of the changed condition in the well is received when a variation between the actual values and the expected values of the optimization parameter at one or more of the predetermined points is determined from the comparison to exceed a predetermined tolerance threshold.

7. The method of claim 6, wherein the downhole tool is a geosteering tool for drilling the well along the planned path, and the downhole data is measured in real-time by one or more sensors coupled to the geosteering tool during the current operating interval of the downhole operation along the portion of the planned path of the well.

8. The method of claim 6, further comprising:
providing, within a graphical user interface (GUI) of a well engineering application executable at a computing device of a user, a visual representation of the expected values and the actual values of the optimization parameter calculated for each of the plurality of operating intervals along the planned path of the well.

9. The method of claim 6, wherein the subsequent operating intervals are automatically updated based on the variation between the actual values and the expected values of the optimization parameter at the one or more of the predetermined points.

10. A system for automating well planning and data analysis for downhole operations, the system comprising:
to at least one processor; and
a memory coupled to the processor having instructions stored therein, which when executed by the processor, cause the processor to perform functions including functions to:
receive input from a user selecting an optimization parameter of interest for a downhole operation to be performed over a plurality of operating intervals along a planned path of a well within a subsurface formation;
estimate values of one or more operational variables for each of the plurality of operating intervals, based on the selected optimization parameter;
provide the estimated values of the one or more operational variables as inputs to a downhole tool for performing the downhole operation over a current one of the plurality of operating intervals along the planned path of the well;
receive an indication that a condition in the well has changed while the downhole operation is performed during the current operating interval;
responsive to the receipt of the indication, update subsequent operating intervals following the current operating interval along with the estimated values of the one or more operational variables for each of the subsequent operating intervals; and
adjust the planned path of the well by providing the updated values of the one or more operational variables as inputs to the downhole tool for performing the downhole operation over the one or more subsequent operating intervals.

11. The system of claim 10, wherein each operating interval is a time range corresponding to a different stage of the downhole operation to be performed along a portion of the planned path of the well.

12. The system of claim 10, wherein each operating interval is a depth range corresponding to a portion of the well along the planned path within the subsurface formation.

13. The system of claim 10, wherein the functions performed by the processor further include functions to:
acquire data for the one or more operational variables from one or more data sources associated with the downhole operation; and
estimate values of one or more operational variables for each of the plurality of operating intervals, based on the acquired data.

14. The system of claim 13, wherein the functions performed by the processor further include functions to:
calculate expected values of an optimization parameter at predetermined points along a portion of the planned path of the well corresponding to the current operating interval, based on the estimated values of the one or more operational variables.

15. The system of claim 14, wherein the functions performed by the processor further include functions to:
calculate actual values of the optimization parameter along the portion of the planned path of the well, based on downhole data collected from the well as the downhole operation is implemented during the current operating interval; and
compare each of the expected values of the optimization parameter with a corresponding one of the actual values of the optimization parameter calculated at each of the predetermined points,
wherein the indication of the changed condition in the well is received when a variation between the actual values and the expected values of the optimization parameter at one or more of the predetermined points is determined from the comparison to exceed a predetermined tolerance threshold.

16. The system of claim 15, wherein the downhole tool is a geosteering tool for drilling the well along the planned path, and the downhole data is measured in real-time by one or more sensors coupled to the geosteering tool during the current operating interval of the downhole operation along the portion of the planned path of the well.

17. The system of claim 15, wherein the functions performed by the processor further include functions to:
provide, within a graphical user interface (GUI) of a well engineering application executable at a computing device of a user, a visual representation of the expected values and the actual values of the optimization parameter calculated for each of the plurality of operating intervals along the planned path of the well.

18. The system of claim 15, wherein the subsequent operating intervals are automatically updated based on the variation between the actual values and the expected values of the optimization parameter at the one or more of the predetermined points.

19. A computer-readable storage medium having instructions stored therein, which when executed by a computer cause the computer to perform a plurality of functions, including functions to:
receive input from a user selecting an optimization parameter of interest for a downhole operation to be performed over a plurality of operating intervals along a planned path of a well within a subsurface formation;
estimate values of one or more operational variables for each of the plurality of operating intervals, based on the selected optimization parameter;
provide the estimated values of the one or more operational variables as inputs to a downhole tool for performing the downhole operation over a current one of the plurality of operating intervals along the planned path of the well;
receive an indication that a condition in the well has changed while the downhole operation is performed during the current operating interval;
responsive to the receipt of the indication, update subsequent operating intervals following the current operating interval along with the estimated values of the one or more operational variables for each of the subsequent operating intervals; and
adjust the planned path of the well by providing the updated values of the one or more operational variables as inputs to the downhole tool for performing the downhole operation over the one or more subsequent operating intervals.

20. The computer-readable storage medium of claim 19, wherein each operating interval is at least one of a depth range or a time range corresponding to a different stage of the downhole operation to be performed along a portion of the planned path of the well.
